(19) United States
(12) Patent Application Publication
(10) Pub. No.: US 2009/0109574 A1
(43) Pub. Date: Apr. 30, 2009

(54) High acceleration seek optimized slider

(75) Inventor: Richard E. Martin, Longmont, CO (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402, US

(73) Assignee: Seagate Technology LLC, Scotts Valley, CA (US)

(21) Appl. No.: 11/925,094

(22) Filed: Oct. 26, 2007

(51) Int. Cl. G11B 5/60

(52) U.S. Cl. 360/235.9

(57) ABSTRACT

A slider includes a slider body having an outer side edge, an inner side edge, an outside rail and an inside rail. The outside rail has an inner edge and an outer edge and is positioned adjacent to the outer side edge of the slider body. The inside rail has an inner edge and an outer edge and is positioned adjacent to the inner side edge of the slider body. The outside rail includes an outer pressurization surface and the inside rail includes an inner pressurization surface. Both pressurization surfaces have an above-ambient fluid pressure when the slider is in flight. The outer pressurization surface extends along the outer edge of the outside rail a length greater than a length that the inner pressurization surface extends along the outer edge of the inside rail.

### BACKGROUND

Typically, data storage systems that utilize magnetic recording technology include a slider for supporting transducers that read and/or write data to a data storage medium. For example, disc drives use one or more rigid discs that include a storage medium for storage of digital information in a plurality of data tracks. Data storage discs are mounted on a spindle motor, which causes the discs to spin and generate airflow. A disc surface passes under a bearing surface of the slider. A lift force from the bearing surface is counteracted by a load force provided by a suspension coupled to the slider to provide the slider with a fly height.

Besides a slider including a bearing surface, a slider can also include carbon dots used to control stiction. Placement of carbon dots on a slider is dictated by two competing effects: stiction and clearance. The capacity for a carbon dot to reduce stiction is largely determined by how close it is placed to a trailing edge of the slider. Conversely, the clearance of a carbon dot from a surface of a disc is derived from the flying pitch angle of the slider and therefore improves as the carbon dot is placed away from the trailing edge of the slider. Ideally, carbon dots placed on a slider should be placed close enough to the trailing edge to mitigate stiction, while maintaining just enough clearance under all operative conditions.

High acceleration seeking of a slider to a specific data track on the storage medium can induce significant inertial effects that tend to reduce carbon dot clearance. In particular, high acceleration seeking of microactuated suspensions can induce inertial effect since the microactuation located in the suspension adds additional mass to the slider. The most significant inertial effect of a slider seeking a data track includes inertial roll moments that are induced at the end of the seek. High acceleration seeking tends to roll the slider and reduce the spacing between the carbon dots and the storage medium surface.

### SUMMARY

A high acceleration seek optimized slider is disclosed that includes a slider body having an outer side edge and an inner side edge. The slider includes an outside rail that has an inner edge and an outer edge and is positioned adjacent to the outer side edge of the slider body. The slider includes an inside rail that has an inner edge and an outer edge and is positioned adjacent to the inner side edge of the slider body.

In some embodiments, the outside rail includes an outer pressurization surface and the inside rail includes an inner pressurization surface. Both pressurization surfaces have an above-ambient fluid pressure when the slider is in flight. The outer pressurization surface extends along the outer edge of the outside rail a length greater than a length that the inner pressurization surface extends along the outer edge of the inside rail.

In other embodiments, the outside rail includes an outer channel leg coupled to an inner channel leg at an outer channel dam to form an outside rail channel. The inside rail includes an outer channel leg coupled to an inner channel leg at an inner channel dam to form an inside rail channel therebetween. Bearing surfaces that define a bearing surface height are included with each of the outside rail and the inside rail. A portion of one of the bearing surfaces is included with the outer channel leg of the outside rail.

Other features and benefits that characterize embodiments of the slider will be apparent upon reading the following detailed description and review of the associated drawings.

### BRIEF DESCRIPTION OF THE DRAWINGS

FIG. 1 is an exploded perspective view of a disc drive.

FIG. 2 is a schematic diagram illustrating geometry of a slider.

FIG. 3 illustrates a plot of seek velocity of a slider over time

FIG. 4 illustrates a plot of an effective skew angle of a slider as the slider traverses a radius of a storage medium during a seek.

FIG. 5-1 illustrates a plot of seek acceleration of a slider over time.

FIG. 5-2 illustrates a plot of seek acceleration of a slider as the slider traverses the radius of a storage medium.

FIG. 6 is a schematic diagram of an end view of a slider illustrating a roll moment.

FIG. 7 is a plot of inertial pitch and roll moments of a slider as the slider traverse a radius of a storage medium.

FIG. 8 illustrates a bottom plan view of a slider under embodiments.

FIG. 9 illustrates a bottom perspective view of the slider illustrated in FIG. 8.

FIG. 10 illustrates a bottom plan view of the slider of FIG. 8 when the slider is at an inner diameter of a storage medium.

FIG. 11 illustrates a bottom plan view of the slider of FIG. 8 when the slider is at an outer diameter of a storage medium.

### DETAILED DESCRIPTION

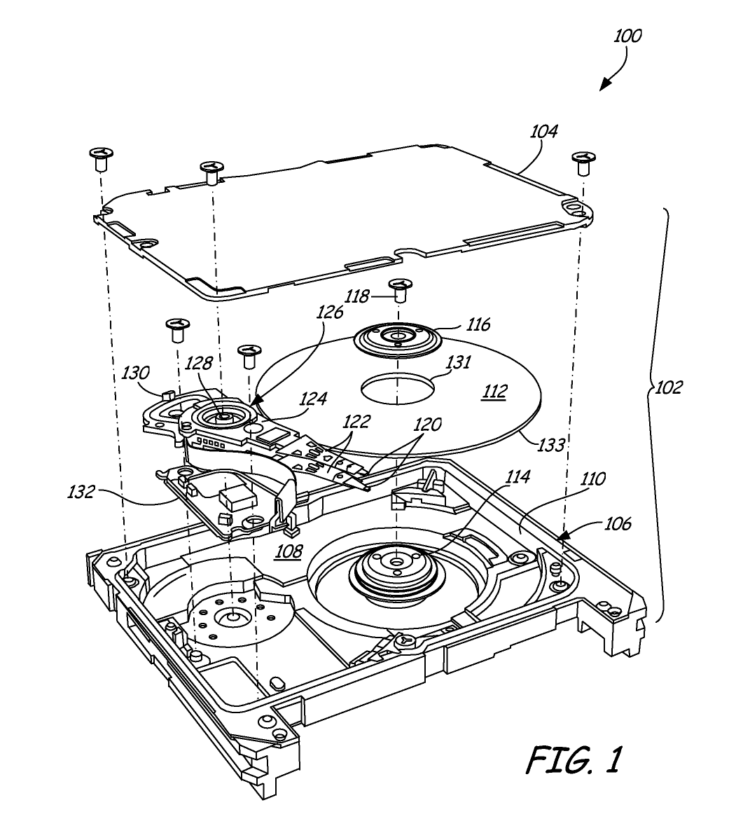

FIG. 1 is an exploded perspective view of a disc drive 100 in which embodiments of the present invention are useful. Disc drives are common data storage systems. One or more embodiments of the present invention are also useful in other types of data storage and non-data storage systems.

Disc drive 100 includes a housing 102 having a cover 104 and a base 106. As shown, cover 104 attaches to base 106 to form an enclosure 108 enclosed by a perimeter wall 110 of base 106. The components of disc drive 100 are assembled to base 106 and are enclosed in enclosure 108 of housing 102. As shown, disc drive 100 includes a disc or medium 112. Although FIG. 1 illustrates medium 112 as a single disc, those skilled in the art should understand that more than one disc can be used in disc drive 100. Medium 112 stores information in a plurality of circular, concentric data tracks and is mounted on a spindle motor assembly 114 by a disc clamp 116 and pin 118. Spindle motor assembly 114 rotates medium 112 causing its data surfaces to pass under respective bearing slider surfaces. Each surface of medium 112 has an associated slider 120, which carries transducers that communicate with the surface of the medium.

In the example shown in FIG. 1, sliders 120 are supported by suspension assemblies 122, which are, in turn, attached to track accessing arms 124 of an actuator mechanism 126. Actuator mechanism 126 is rotated about a shaft 128 by a voice coil motor 130, which is controlled by servo control circuitry within circuit 132. Voice coil motor 130 rotates actuator mechanism 126 to position sliders 120 relative to desired data tracks, between a disc inner diameter 131 and a disc outer diameter 133.

Slider 120 includes features on it bottom surface for maintaining a fly height over a surface of medium 112. One particular feature includes carbon dots placed on the bottom of slider 120 to prevent stiction (e.g., the tendency for the slider to stick to the medium as a result of static friction). Placing carbon dots close to a trailing edge (where read/write transducers are located) of a slider provides greater prevention of stiction. However, clearance of the carbon dots from the medium as determined by fly pitch angle improve as the carbon dots are placed away from the trailing edge of the slider. Clearance of carbon dots on the slider are also compromised during high acceleration seeking of a slider.

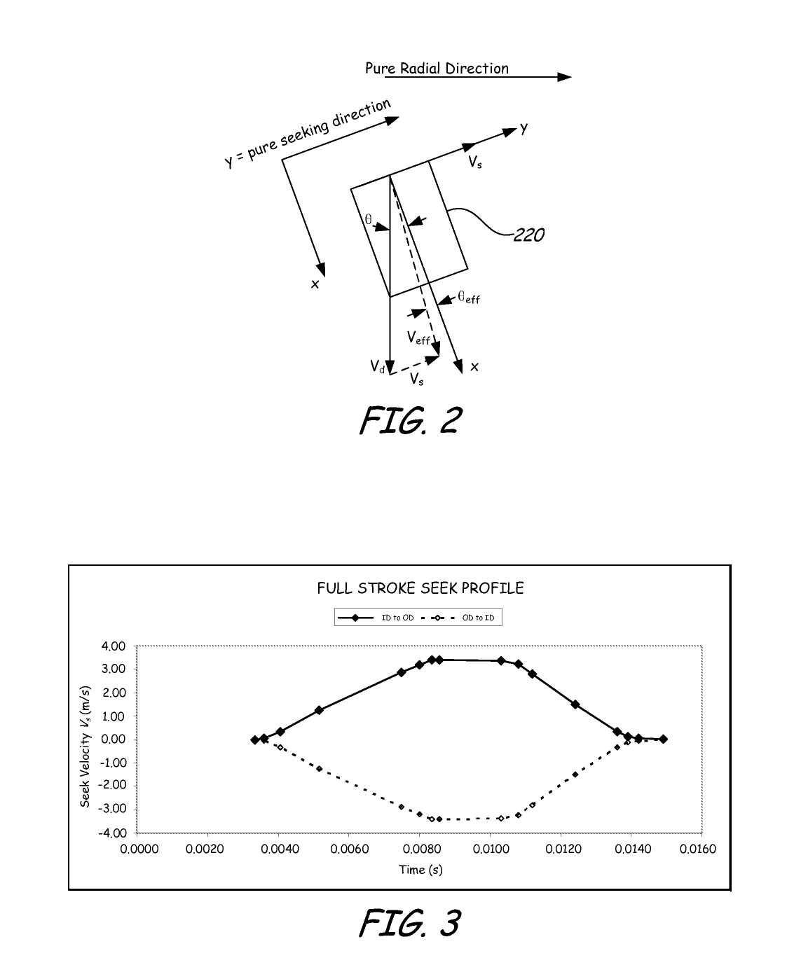

Before discussing detailed embodiments of a seek optimized slider for high acceleration seeks, it may be beneficial to discuss the seek modeling of a slider. FIG. 2 illustrates a schematic diagram illustrating a geometry of a slider 220. In general, seek modeling of a slider is typically carried out either through a simple static model or through a fully dynamic seek model. A simple static model only includes the effects of effective skew angle (θ_{eff}) and velocity (V_{eff}) described by the equations:

$$\begin{matrix}{V}_{eff} = \sqrt{{V}_{s}^{2} + 2 {V}_{s} {V}_{D} sin θ + {V}_{d}^{2}} & ( 1 ) \\ and & \\ {θ}_{eff} = arctan [ \frac{{V}_{s} + {V}_{d} sin θ}{{V}_{d} cos θ} ] & ( 2 )\end{matrix}$$

where Vₛ is the seek velocity, V_{d} is the slider to medium relative velocity and θ is the actual skew angle. Effective skew angle (θ_{eff}), effective velocity (V_{eff}), seek velocity (Vₛ), slider to medium relative velocity (V_{d}) and actual skew angle (θ) are illustrated in FIG. 2. A fully dynamic seek model is cumbersome to set up, extremely computationally demanding and generally predicts seek-induced fly height changes that are very close to those predicted in the simple static model. Therefore, a simple static model is often relied on versus the fully dynamic model. However, the simple static model completely ignores all inertial effects, which are the primary factors in determining carbon dot clearance. To determine why carbon dot clearance is limited in high acceleration seeks, a quasi-static model that includes inertial seek effects is employed.

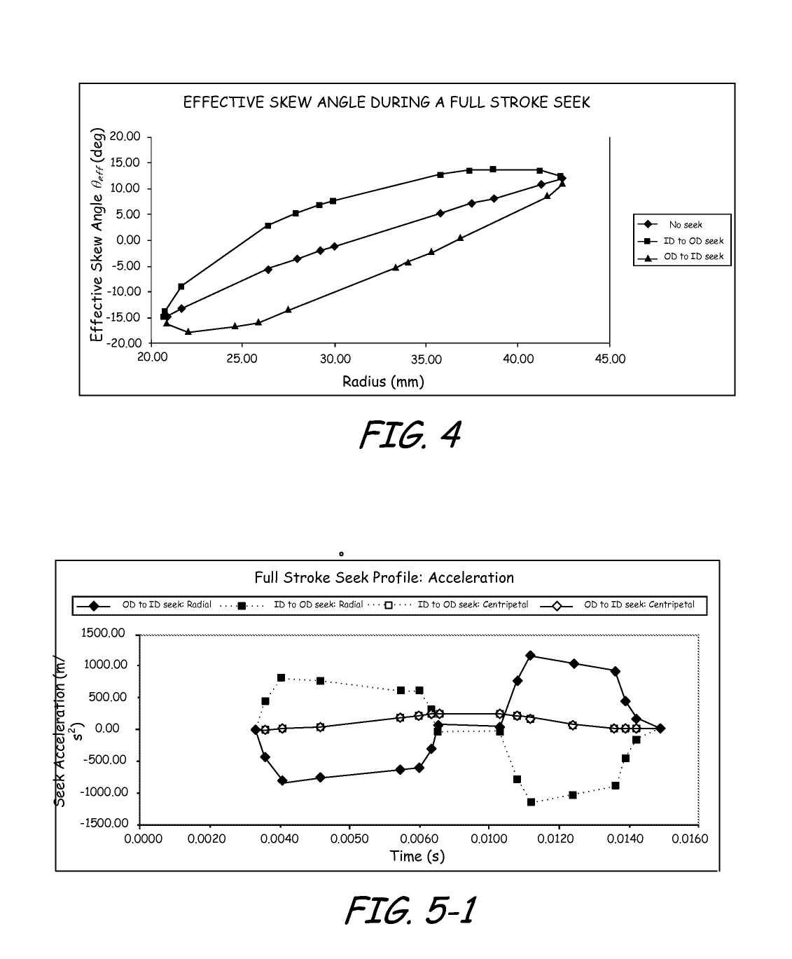

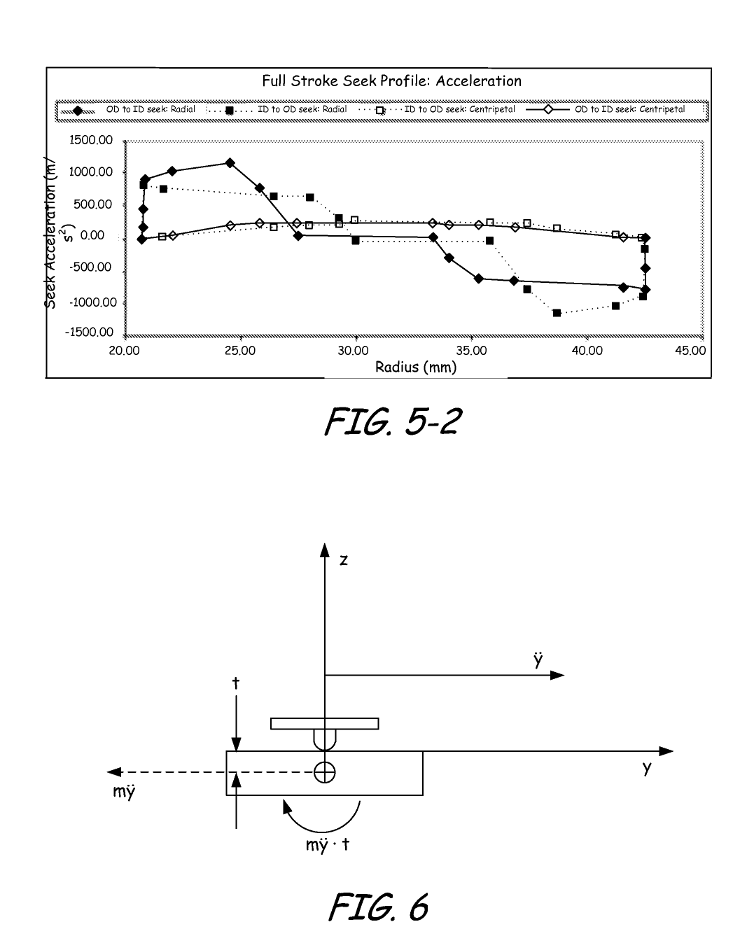

Inertial seek effects depend on seek acceleration. Radial seek accelerations are obtained by calculating effective skew angles (θ_{eff}) and effective velocities from equations 1 and 2 from the simple static model, plotting a seek velocity profile of a slider including seek velocity (Vₛ) with respect to time as illustrated in FIG. 3 and plotting effective skew angle profiles including effective seek angles (θ_{eff}) with respect to time as illustrated in FIG. 4. To obtain radial seek accelerations, the velocity profiles in FIG. 3 are differentiated with respect to time. Results are plotted against time in FIG. 5-1 and against radius in FIG. 5-2.

Since an actuator mechanism, such as actuator mechanism 126 (FIG. 1) sweeps out a circular arc between an inner diameter, such as inner diameter 131, and an outer diameter, such as outer diameter 133, during seek, centripetal accelerations are also considered in the quasi-static model. Centripetal acceleration is in the x-direction and given by:

$$\frac{{V}_{s}^{2}}{R} \qquad ( 3 )$$

where R is the distance form the actuator pivot, such as shaft 128 (FIG. 1), to a read/write gap of the read/write transducer on the slider. In accordance with FIGS. 5-1 and 5-2, the centripetal seek acceleration is roughly five times less than the corresponding radial acceleration. Thus, inertial roll moments dominate seek effects.

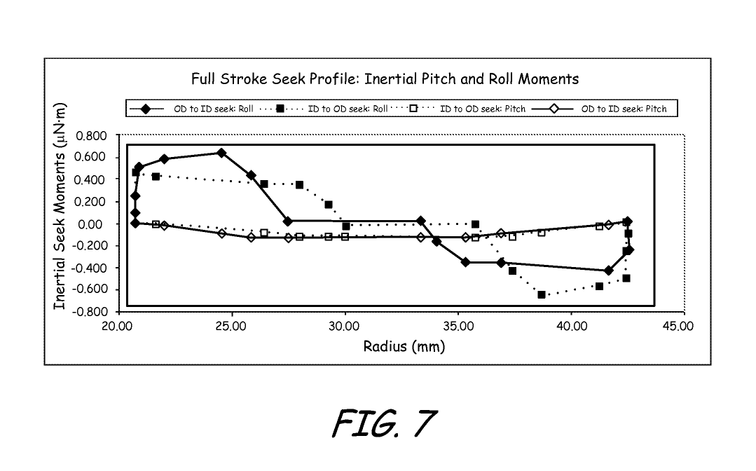

FIG. 6 illustrates an end view of slider 220. FIG. 7 illustrates a radial seek acceleration of a magnitude ÿ in the positive y-direction. Slider 220 is coupled to a suspension, such as a suspension 122 (FIG. 1), through a gimbal at z=0 and is free to rotate about the x and y-axes (i.e., the roll and pitch directions respectively). Given that m is the combined mass of the slider and any microactuator of the suspension, then an inertial force of magnitude mÿ is induced by the seek acceleration at the center of mass of the suspension, gimbal and slider 220. The center of mass of slider 220, the suspension and the gimbal is separated from the origin by a distance (t). Thus, an inertial roll moment about the x-axis of magnitude is generated that is equal to:

mÿ·t (4)

Similarly, the centripetal acceleration induces an inertial pitch moment (not shown in FIG. 6) about the y-axis of magnitude that is equal to:

$$m \frac{{V}_{s}^{2}}{R} \cdot t \qquad ( 5 )$$

In accordance with FIG. 5-1, the radial seek acceleration is positive at the start of an inner diameter (ID) to an outer diameter (OD) of the data storage disc seek and negative at the start of an OD to ID seek. In accordance with FIG. 5-2, the radial seek acceleration at the ID is positive for both ID to OD and OD to ID seeks. When a seek is initiated at the ID, slider 220 is accelerated toward the OD, which tends to increase flying roll angle. When the seek is initiated from the OD, slider 220 reaches maximum velocity near the middle of the stroke and then decelerates near the ID. In either case, the slider is being accelerated toward the OD when it is at the ID. It is for this reason that flying roll angle at the inner diameter of the data storage disc is always increased by seeking. A calculation of the inertial pitch and roll moments using equations 4 and 5 are illustrated in FIG. 7.

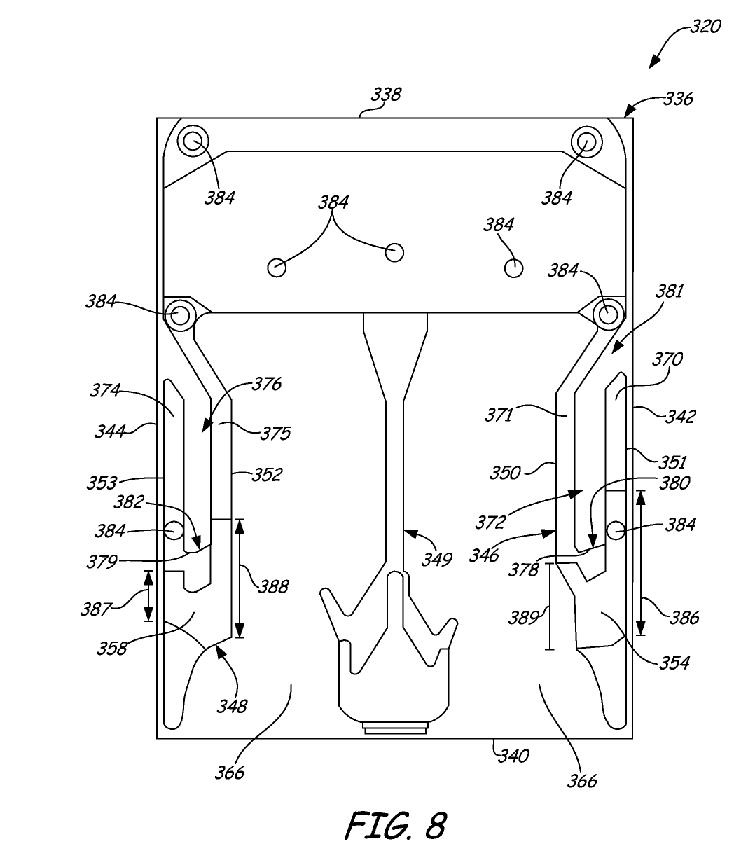

FIG. 8 illustrates a bottom plan view of a slider 320 under one embodiment. Slider 320 includes a slider body 336 having a leading edge 338, a trailing edge 340, an outer side edge 342 and an inner side edge 344. Edge 342 is defined as an outer side edge because it is oriented towards the outer diameter of a storage medium when the slider is attached to an actuator mechanism and suspension. Edge 344 is defined as an inner side edge because it is oriented towards the inner diameter of a storage medium when the slider is attached to an actuator mechanism.

Slider 320 includes an outside rail 346, an inside rail 348 and a center rail 349. Outside rail 346 has an inner edge 350 and an outer edge 351. Outside rail 346 is positioned between trailing edge 340 and leading edge 338 and is adjacent outer side edge 342 of slider body 336. Inside rail 348 has an inner edge 352 and an outer edge 353. Inside rail 348 is positioned between trailing edge 340 and leading edge 338 and is adjacent inner side edge 344 of slider body 336. Center rail 349 is also positioned between trailing edge 340 and leading edge 338 of slider body 336. Center rail 348 is also positioned between outside rail 346 and inside rail 348. A portion of each of outside rail 346, inside rail 348 and center rail 349 includes a bearing surface, while other portions of each of outside rail 346, inside rail 348 and center rail 349 include step surfaces. Outside rail 346, inside rail 348 and center rail 349 all protrude from a cavity surface 366.

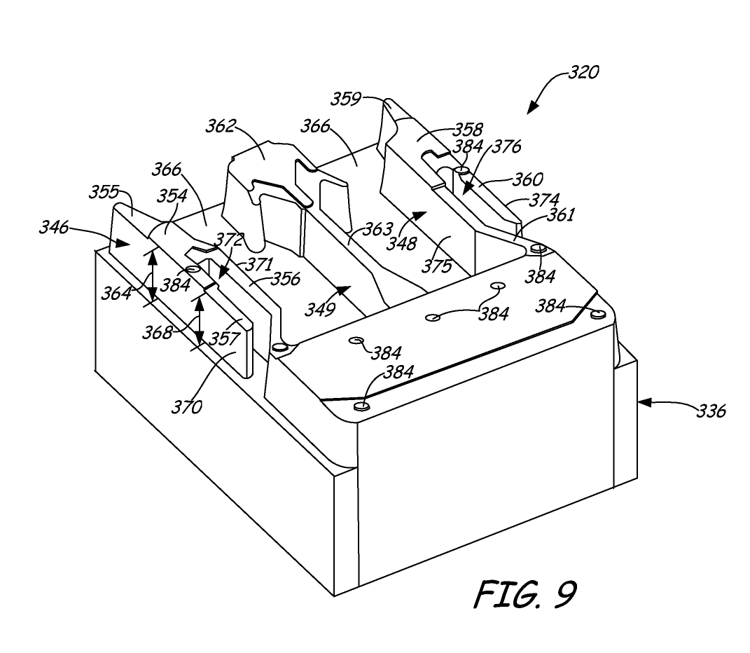

FIG. 9 illustrates a bottom perspective view of slider 320 of FIG. 8. As illustrated, outside rail 346 includes bearing surface 354 and step surfaces 355, 356 and 357. Inside rail 348 includes bearing surface 358 and step surfaces 359, 360 and 361. Center rail 349 includes bearing surface 362 and step surface 363. Bearing surfaces 354, 358 and 362 are defined by a bearing surface height 364. Bearing surface height 364 is the distance from which bearing surfaces 354, 358 and 362 of outside rail 346, inside rail 348 and center rail 349 protrude from cavity surface 366 of slider body 336. Step surfaces 355, 356, 357, 359, 360, 361 and 363 are defined by a step surface height 368. Step surface height 368 is the distance from which step surfaces 355, 356, 357, 359, 360, 361 and 363 protrude from cavity surface 366. As illustrated, bearing surface height 364 is greater than step surface height 368.

With reference to both FIGS. 8 and 9, outside rail 346 includes an outer channel leg 370 defined by at least a portion of outer edge 351 and an inner channel leg 371 defined by at least a portion of inner edge 350. Outer channel leg 370 and inner channel leg 371 of outside rail 346 are coupled to form an outside rail channel 372 therebetween. Inside rail 348 includes an outer channel leg 374 defined by at least a portion of outer edge 353 and an inner channel leg 375 defined by at least a portion of inner edge 352. Outer channel leg 374 and inner channel leg 375 of inside rail 348 are coupled to form an inside rail channel 376 therebetween. In one embodiment, outer channel leg 370 and inner channel leg 371 of outside rail 346 are coupled together at an outside channel dam 378 (FIG. 8). In another embodiment, outer channel leg 374 and inner channel leg 375 of inside rail 348 are coupled together at an inside channel dam 379 (FIG. 8).

Outside rail channel 372 includes a first end 380 (FIG. 8) and a second end (FIG. 8) 381. First end 380 of outside rail channel 372 is located at outside channel dam 378. Second end 381 of outside rail channel 372 is in fluidic communication with outer side edge 342 of slider body 336. Inside rail channel 376 includes a first end 382 (FIG. 8) and a second end 383 (FIG. 8). First end 382 of inside rail channel 376 is located at inside channel dam 379. Second end 383 of inside rail channel 376 is fluidic communication with open to inner side edge 344 of slider body 336.

Bearing surface 354 located at bearing surface height 364 of outside rail 346 is an outer pressurization surface having an above-ambient fluid pressure when slider 320 is in flight. Airflow (or other type of fluid) enters outside rail channel 372 at second end 381. Airflow is dammed by outside channel dam 378 and provides bearing surface 354 or the outer pressurization surface with the above-ambient fluid pressure. Bearing surface 358 located at bearing surface height 364 of inside rail 348 is an inner pressurization surface having an above-ambient fluid pressure when slider 320 is in flight. Airflow (or other type of fluid) enters inside rail channel 376 at second end 383. Air is dammed by inside channel dam 379 and provides bearing surface 358 or the inner pressurization surface with the above-ambient fluid pressure. An above-ambient fluid pressure at the outer pressurization surface 354 provides slider body 336 with high roll stiffness.

Slider 320 also includes carbon dots 384 used to control stiction. Placement of carbon dots 384 on slider 320 is dictated by the reduction of stiction and clearance of the carbon dots from a medium, such as medium 112 (FIG. 1). As previously discussed, carbon dots 384 should be placed as close to trailing edge 340 of slider 320 to mitigate stiction without compromising clearance of a storage medium, such as medium 112 (FIG. 1), under operative conditions. However, as discussed with reference to FIGS. 2-7, high acceleration seeking of a slider to a specific data track on the storage medium can induce significant inertial effects that tend to reduce carbon dot clearance. In particular, when a slider is being accelerated toward the outer diameter of a storage medium when it is at the inner diameter of a storage medium. High acceleration seeking tends to cause inertial roll movements that roll the slider and reduce the spacing between the carbon dots and the storage medium surface.

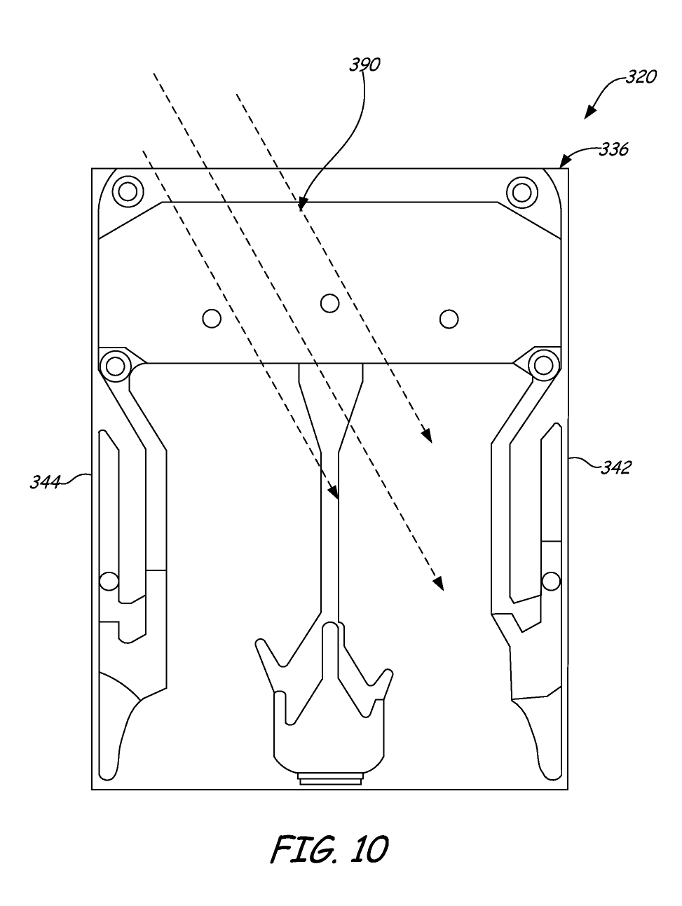

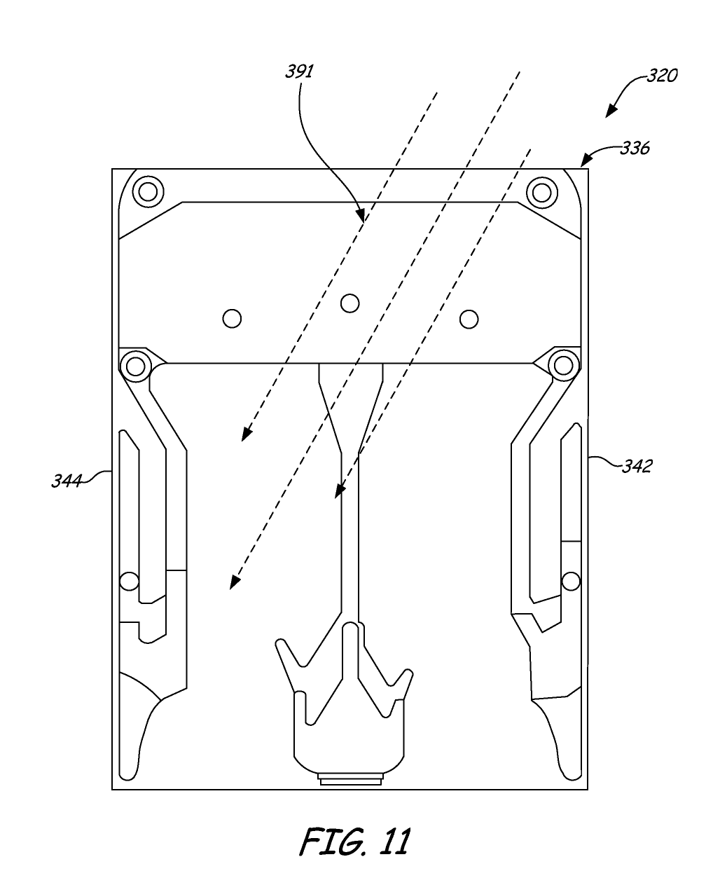

To allow carbon dots 384 to clear a storage medium, an increase lift on outside rail 346 relative to inside rail 348 is needed when slider 320 is at the inner diameter of a storage medium. This can be achieved by outside rail 346 having more material at its outer edge 351 than material on the outer edge 353 of inside rail 348. Such a configuration allows slider 320 to produce a negative roll. As airflow 390 moves from inner side edge 344 to outer side edge 342 of slider body 336 (as illustrated in FIG. 10) when slider 320 is at the inner diameter of a storage medium, added material to outer edge 351 of outside rail 346 increases the overall lift at outside rail 346. In one embodiment and as illustrated in FIG. 8, the outer pressurization surface or bearing surface 354 extends along outer edge 351 of outside rail 346 at a length 386. The inner pressurization surface or bearing surface 358 extends along outer edge 353 of inside rail 348 of outside rail 346 at a length 387 of inside rail 348. In this embodiment, length 386 is greater than length 387. In another embodiment and as illustrated in FIG. 8, a portion of the outer pressurization surface or bearing surface 354 is located on outer channel leg 370 of outside rail 346, while none of the inner pressurization surface or bearing surface 358 is located on outer channel leg 374 of inside rail 348. In yet another embodiment and as illustrated in FIG. 9, step surface 360 included with outer channel leg 374 of inside rail 348 has a greater step surface area than step surface 357 included with outer channel leg 370 of outside rail 346.

Furthermore, when slider 320 is at the outer diameter of a storage medium, the negative roll of slider 320 induced by the added material to outside rail 346 can not be too negative. To ensure negative roll is not too negative at the outer diameter, less material can be included with outside rail 346 at an inner edge 350 compared to the amount of material included with inside rail 348 at an inner edge 352. As airflow 391 moves from outer side edge 342 to inner side edge 344 of slider body 336 (as illustrated in FIG. 11) when slider 320 is at an outer diameter of storage medium, less material at inner edge 350 of outside rail 346 ensures that the negative roll of slider 320 induced by adding material to outer edge 351 of outside rail 346 is not too negative. In one embodiment and as illustrated in FIG. 8, the inner pressurization surface or bearing surface 358 extends along inner edge 352 of inside rail 348 at a length 388. Length 388 is greater than a length 389 that the outer pressurization surface or bearing surface 354 extends along inner edge 350 of outside rail 346. In another embodiment and as illustrated in FIG. 8, a portion of the inner pressurization surface or bearing surface 358 is located with inner channel leg 375 of inside rail 346, while none of the outer pressurization surface or bearing surface 354 is located with inner channel leg 371 of outside rail 346. In another embodiment and as illustrated in FIG. 9, step surface 356 included with inner channel leg 371 of outside rail 346 has a greater step surface area than step surface 361 included with inner channel leg 375 of inside rail 348.

The optimized high acceleration seek slider 320 illustrated in FIGS. 8-11 induces a negative roll moment when the slider is at the inner diameter of a storage medium to counteract the decrease in fly height that normally occurs at this position. The induced negative roll allows optimal carbon dot clearance. In addition, the high roll stiffness of slider body 336 induced by outside rail channel 372 and inside rail channel 376 also counteracts the maximum decrease in fly height that normally occurs at the inner diameter of the storage medium.

It is to be understood that even though numerous characteristics and advantages of various embodiments of the invention have been set forth in the foregoing description, together with details of the structure and function of various embodiments, this disclosure is illustrative only, and changes may be made in detail, especially in matters of structure and arrangement of parts within the principles of the disclosure to the full extent indicated by the broad general meaning of the terms in which the appended claims are expressed. For example, the particular elements may vary depending on the type of construction of a slider while maintaining substantially the same functionality without departing from the scope and spirit of the present invention. In addition, although the preferred embodiment described herein is directed to a slider for a disc drive, it will be appreciated by those skilled in the art that the teachings of the present invention can be applied to other types of sliders, without departing from the scope and spirit of the present invention.

What is claimed is:

1. A slider comprising:
a slider body having an outer side edge and an inner side edge;
an outside rail having an inner edge and an outer edge and positioned adjacent to the outer side edge of the slider body, the outside rail including an outer pressurization surface having an above-ambient fluid pressure when the slider is in flight;
an inside rail having an inner edge and an outer edge and positioned adjacent to the inner side edge of the slider body, the inside rail including an inner pressurization surface having an above-ambient fluid pressure when the slider is in flight; and
wherein the outer pressurization surface extends along the outer edge of the outside rail a length greater than a length that the inner pressurization surface extends along the outer edge of the inside rail.

2. The slider of claim 1, wherein the inner pressurization surface extends along the inner edge of the inside rail a length greater than a length that the outer pressurization surface extends along the inner edge of the outside rail.

3. The slider of claim 1, wherein the outside rail comprises a first outer channel leg defined by at least a portion of the outer edge of the outside rail and a first inner channel leg defined by at least a portion of the inner edge of the outside rail, wherein the first outside channel leg is coupled to the first inner channel leg at an outer channel dam to form an outer rail channel therebetween, wherein the outer rail channel is configured to provide the above-ambient fluid pressure to the outer pressurization surface when the slider is in flight.

4. The slider of claim 3, wherein a portion of the outer pressurization surface is located on the first outer channel leg of the outside rail.

5. The slider of claim 3, wherein the first outer channel comprises a first end located at the outer channel dam and a second end, the second end is in fluidic communication with the outer side edge of the slider body.

6. The slider of claim 3, wherein the inside rail comprises a second outer channel leg defined by a portion of the outer edge of the inside rail and a second inner channel leg defined by a portion of the inner edge of the inside rail, wherein the second outer channel leg is coupled to the second inner channel leg at an inner channel dam to form an inside rail channel therebetween, wherein the inner rail channel is configured to provide the above-ambient fluid pressure to the inner pressurization surface when the slider is in flight.

7. The slider of claim 6, wherein a portion of the inner pressurization surface is located on the second inner channel leg of the inside rail.

8. The slider of claim 6, wherein the inner rail channel comprises a first end located at the inner channel dam and a second end, the second end is in fluidic communication with the inner side edge of the slider body.

9. A slider comprising:
a slider body having an outer side edge and an inner side edge;
an outside rail positioned adjacent to the outer side edge, the outside rail including an outer channel leg coupled to an inner channel leg at an outer channel dam to form an outside rail channel therebetween;
an inside rail positioned adjacent to the inner side edge, the inside rail including an outer channel leg coupled to an inner channel leg at an inner channel dam to form an inside rail channel therebetween; and
bearing surfaces defining a bearing surface height included with each of the outside rail and the inside rail, wherein a portion of one of the bearing surfaces is included with the outer channel leg of the outside rail.

10. The slider of claim 9, wherein a portion of one of the bearing surfaces is included with the inner channel leg of the inside rail.

11. The slider of claim 9, wherein the outside rail channel includes a first end located at the channel dam and a second end, the second end is in fluidic communication with the outer side edge of the slider body.

12. The slider of claim 9, wherein the inside rail channel includes a first end located at the channel dam and a second end, the second end is in fluidic communication with the inner side edge of the slider body.

13. The slider of claim 9, further comprising step surfaces defining a step surface height that is less than the bearing surface height of the bearing surfaces, wherein the step surfaces are included with the outside rail and the inside rail.

14. The slider of claim 13, wherein the inner channel leg of the outside rail includes one of the step surfaces having a greater step surface area than one of the step surfaces included with the inner channel leg of the inside rail.

15. The slider of claim 13, wherein the outer channel leg of the inside rail includes one of the step surfaces having a greater step surface area than one of the step surfaces included with the outer channel leg of the outside rail.

16. The slider of claim 9, wherein the bearing surface included with the outside rail extends along an outer edge of the outside rail a length greater than a length that the bearing surface included with the inside rail extends along the outer edge of the inside rail.

17. The slider of claim 9, further comprising a cavity surface located in the outside channel between the outer channel leg and the inner channel leg of the outside rail, in the inside channel between the outer channel leg and the inner channel leg of the inside rail and between the inside rail and the outside rail, the bearing surfaces protruding from the cavity surface by the bearing surface height.

18. The slider of claim 9, further comprising a center rail positioned between the outside rail and the inside rail, the center rail including a bearing surface defined by the bearing surface height and a step surface defined by a step surface height that is less than the bearing surface height.

19. A slider comprising:
bearing surfaces that protrude from a cavity surface by a bearing surface height;
step surfaces that protrude from the cavity surface by a step surface height, wherein the bearing surface height is greater than the step surface height;
an outside rail partially positioned at the bearing surface height and partially positioned at the step surface height, the outside rail including an outer channel leg and an inner channel leg;
an inside rail partially positioned at the bearing surface height and partially positioned at the step surface height, the inside rail including an outer channel leg and an inner channel leg;
wherein a portion of the one of the bearing surfaces is located on the outer channel leg of the outside rail.

20. The slider of claim 19, wherein a portion of one of the bearing surfaces is located at the inner channel leg of the inside rail.
